(19) United States
(12) Patent Application Publication
(10) Pub. No.: US 2002/0078365 A1
(43) Pub. Date: Jun. 20, 2002

(54) Method for securely enabling an application to impersonate another user in an external authorization manager

(75) Inventors: Rodney Carl Burnett, Austin, TX (US); Timothy Simon Bartley, Austin, TX (US); Michael Powell, Carrara Qld (AU)

Correspondence Address: Darcell Walker, 8107 Carvel Lane, Houston, TX, 77036, US

(73) Assignee: INTERNATIONAL BUSINESS MACHINES CORPORATION, ARMONK, NY (US)

(21) Appl. No.: 09/738,245

(22) Filed: Dec. 15, 2000

(51) Int. Cl. G06F 11/30

(52) U.S. Cl. 713/200

(57) ABSTRACT

The present invention is an algorithm that manages the ability of an impersonator program to impersonate a user identity. This invention operates in the context of an external security manager. One aspect of the invention is a technique in which a security manager is used to control the security of an impersonator program and to allow that impersonator program's impersonated user to be represented as a user identity in that external security manager. A second aspect of the present invention is a technique that controls an impersonator program's ability to change its user identity. This invention will allow the specification of security policy to control which users an impersonator program can impersonate.

### FIELD OF THE INVENTION

The present invention relates generally to the enabling of a computer application program to impersonate a user in a computer system and more particularly to the enabling an external authorization manager to control the ability of a computer application program to impersonate a user in a computer system, and then use the impersonated user in subsequent authorization decisions.

### BACKGROUND OF THE INVENTION

Impersonator programs are applications, which act as proxies performing services on behalf of potentially many users. A user will request that the impersonator program perform some task for the user. Two examples of impersonator programs are mail servers and the UNIX cron process. Many of these impersonator programs initially run under a master identity. The main feature of an impersonator program is that it has the ability to change its identity from one user to another user. An impersonator program temporarily impersonates a user for the purpose of performing some operation on resources that are accessible by the impersonated user. Following the completion of the operation, the impersonator program will resume its initial identity. With this ability to change user identities, the impersonator program can run requested operations as the requesting user in order to access and manage resources on behalf of and accessible by the requester. The need to change user identities requires that the impersonator program be granted a high level of privilege. In a UNIX system, the privilege identity is the root user. The impersonator application changes its current running identity using a setuid( ) call or one of its variants.

In computer systems, user identity authentication is necessary to allow the user access to system resources. The user identity authentication occurs with the use of a user password. Once there has been an authenticated user, access controls are implemented to determine which resources are available to that user. Certain privileged identities exist which have access to all system resources including the ability to change to a user identity without authentication. Impersonator programs run under a privileged identity to gain the ability to change user identities and access resources that are available to that user. Gaining this capability also gives the impersonator programs access to all system resources. There are some basic reasons why this broad access is undesirable.

The potential for unauthorized use of computing resources by an impersonator creates a system security risk. This potential for security compromises is expanded because of the nature of system security with respect to impersonator programs. The security system model used in impersonator programs is a primitive course grained model. This model enables an application to surrogate to other users for the purpose of impersonation with complete system privilege. With a complete privilege, there are no restrictions placed on what users the application can impersonate. In addition, as a root user, the impersonation application has access to all resources on the running system. This level of privilege and access is unacceptable for environments with stringent security goals.

To address this broad level of privilege, external security managers can be created that augment standard UNIX security in the native operating system. These security managers support the definition of fine-grained rich security policy including more control over the privilege granted to the UNIX root user. Usually, the security manager maintains enhanced external user definitions. These user definitions contain extended information such as user group membership or roles. The security manager re-maps the local system user to its external user on resource accesses in order to make authorization decisions. In such a system, a unique set of policy definitions and enforcement methods can be added to support impersonator applications. These enhanced methods enable the security manager to allow operations of impersonator programs while restricting the privilege of an impersonator application program and thereby providing a greater level of security control over the impersonation program capabilities. Furthermore, these methods can be applied in such a way to avoid the need for modification and enhancement to the impersonator application.

Software computing system capable of making authorization decisions based on security policy defined external to the native system and on extended user identity properties defined outside the native system's user registry already exist in the practiced art. These systems typically maintain a repository of access controls along with a user registry defining accessing users within the system. Such systems may be implemented across a network of computers with policy and user registry information residing on computer systems in the network. The access rules may be in the form of Access Control Lists (ACLs). Access resources can be defined using common names for the resources and may be hierarchical in nature. For example a file resource might be defined as /AZN₁₃ RESOURCES/home/joe/datafile or a change user identity resource may be defined as /AZN_RESOURCES/surrogate/joe. Such a system may also be capable of attaching extended attributes to the defined resources or the resource name itself could imply security properties.

An operating system security manager (OS Sec Mgr.) can be created to enforce defined security policy on system computing resources. The security manager intervenes in accesses to managed system resources and consults the authorization policy to make access decisions. On a resource access, resource information, operation, and access conditions are retrieved. Targeted resources include files, network resources, and user identities. The operations used to access and manage the resources are monitored and intercepted. Example operations are reads of files, attempts to connect to a network resource, login attempts, or attempts to change (surrogate) to another user identity within a process. The accessing user identity is mapped into the OS Sec Mgr. user definitions and is based on the identity that was obtained at system login. The mapping mechanism would be implementation dependent, but potentially would involve mapping the native numerical user identity into the OS Sec Mgr's identity representation. This identity is retained for mapping even after a surrogate operation so that OS Sec Mgr. enforcement applies to the authenticated identity. This mapping model provides a higher level of security by enforcing security on the identity represented with the authenticated login. It also prevents one user from obtaining access to another user's resources or from subverting its own restrictions after a surrogate operation.

The above described software system provides the ability to enhance the course native UNIX security model with a fine grained model where access to system resources can controlled down to selected individual users, groups, or roles. This software system's external nature further provides the ability to restrict the privilege of otherwise fully privileged identities such as the root identity. This identity can be limited to what system resources it can access, and what operations it can perform. This software system also includes the ability to determine and control the other native system user identities to which root can perform a surrogate operation. However, the described computing system is not sufficient for the support of impersonation applications and therefore, this system needs further enhancements to address the concerns surrounding impersonation applications. The impersonation applications need the ability to change user identities and then access resources as the changed identity. If the resources are protected in the OS Sec Mgr, then access may be denied since it would be based on the initial identity of the impersonation program. This denial would break the application and yield it unusable in the OS Sec Mgr. environment. Existing external security manager implementations have avoided this problem by granting the impersonator program complete access to all resources. This approach negates the benefits of the OS Sec Mgr and exposes the system to security risks. It also prevents control of what target users the impersonator program can impersonate.

There remains a need for additional techniques to achieve an OS Sec Mgr, which is capable of supporting impersonation applications while maintaining a high level of security with respect to those applications. In addition, it is a significant benefit that the technique provides this transparently to the application without requiring application modification.

### SUMMARY OF THE INVENTION

It is an object of the present invention to provide a method for managing the ability of an impersonator program to impersonate a user in a computing environment

It is another objective of the present invention to represent the impersonated user in an external authorization processing system.

It is third objective of the present invention to be able to determine if a program is an impersonator program at the start of that program's execution.

It is fourth objective of the present invention to limit the execution capabilities of an impersonator program.

It is another objective of the present invention to avoid the modification of the impersonation program or other application programs in such a computing environment.

It is another objective of the present invention to control which users an impersonation program may impersonate.

It is another objective of the present invention to improve the overall security in a computing environment through the management of impersonator programs.

This invention has the ability for an existing unmodified proxy application to act as another user with respect to an external security engine. The present invention is an algorithm that manages the ability of an impersonator program to impersonate a user identity. This invention operates in the context of an external security manager. Therefore, in the operation of the present invention, there is an assumption that there is some type of external security manager program that can make security decisions for the computing environment. One aspect of the invention is a technique, which uses a security manager to control the security of an impersonator program and allow that impersonator program and its initial running identity to be represented in that external security manager. In this technique, the present invention determines whether a program that is starting to execute is an impersonator program. Ideally this information would be definable and retrievable as a resource attribute in the external security manager. However, it could be defined through other means such as in a local protected file that lists impersonator programs. The technique only assumes the information is available. If the program is an impersonator program, the program is tracked and is handled specially when it performs surrogate operations to different user identities. If the impersonator program has the requisite privileges to execute, the security manager will allow that impersonator program to execute. If the impersonator program does not have the requisite privilege, the security manager will deny that impersonator program the right to execute in that computer environment.

A second aspect of the present invention is a technique that controls an impersonator program's ability to change its user identity. This invention will allow the specification of security policy to control which users an impersonator program can impersonate. In this technique, the present invention will determine the current user under which an impersonator program is executing, and the impersonator's target impersonation user. The present invention will then contact the security manager to determine if the impersonator program can surrogate to and thus impersonate a new user. If the impersonator program does a successful surrogate operation, its maintained user identity will be set such that the access user (the user that will be invoking the commands) of the program is now the new user for the purpose of subsequent authorization decisions that are made in the external security manager when that impersonator program accesses certain resources in the computing environment

### DESCRIPTION OF THE DRAWINGS

FIG. 1 is a flow diagram of the steps involved in determining if an impersonator program is allowed to execute in a computer environment.

FIG. 2 is a flow diagram of the steps to determine whether an impersonator program can change to a new user identity.

FIG. 3 is a block diagram of the high-level architecture relationship between an external security manager and an impersonator program.

### DETAILED DESCRIPTION OF THE INVENTION

This invention describes these techniques for controlling the ability of an impersonator program to operate on a computer system. The algorithm of this invention for enabling secure impersonation involves: 1) the use of an “impersonator” trusted computing base (TCB) property; and 2) management of an impersonator program's ability to change its current user identity to another user identity.

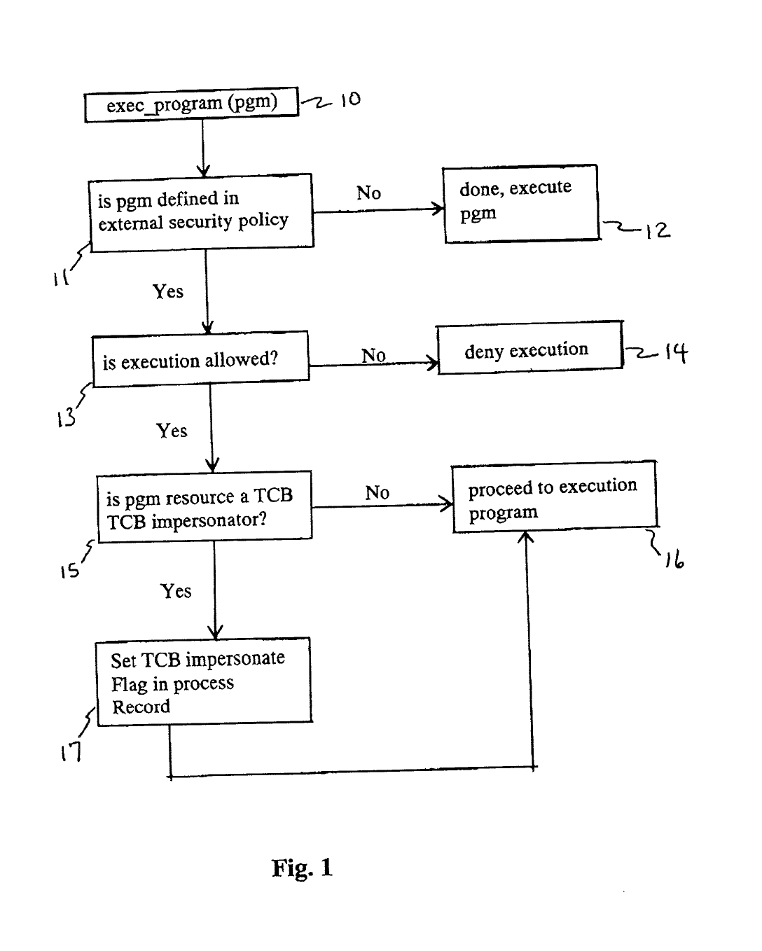

Referring to FIG. 1, one aspect of the invention is a technique in which a security manager is used to control the security of an impersonator program and allow that impersonator program to be represented as a user identity in that external security manager. In this process, when the security manager recognizes that a program is starting to execute on a machine, the algorithm of the present invention performs a check to determine 10 if this starting program is defined as an impersonator program 11. If the program is not in the extended security manager, there is not further relevant processing involving the present invention 12. If the program is in the extended security manager, then another check is performed to determine whether the external security manager permits the execution of the program on the system 13. If the determination is that the program is not allowed to execute, then the security manager denies execution 14 and the algorithm of the present invention ends. The denial of execution could be because the security policy may have guidelines to only allow execution of a program under defined requirements. One requirement could be time restrictions for certain applications to execute. One example could be applications that are only allowed to run on certain days of the week or only allowed to run at certain times during the day. If the application is allowed to run, there is a determination of whether that application is an impersonator program 15. Again, if the answer is no, then this application is not relevant to the algorithm of the present invention. The application will proceed to execution 16. If the conclusion is that the application is an impersonator program, then the state of that application is tracked in an internal process record data structure (track the fact that the application is an impersonator application). The process record is marked with a TCB impersonator flag 17, and the initial native user identity, which started the impersonation program, is recorded. The program then proceeds to execute 16. Information about the impersonator program is saved in a state machine. In an assumed implementation, there is a place to store and record that information identifying that impersonator program in a given process.

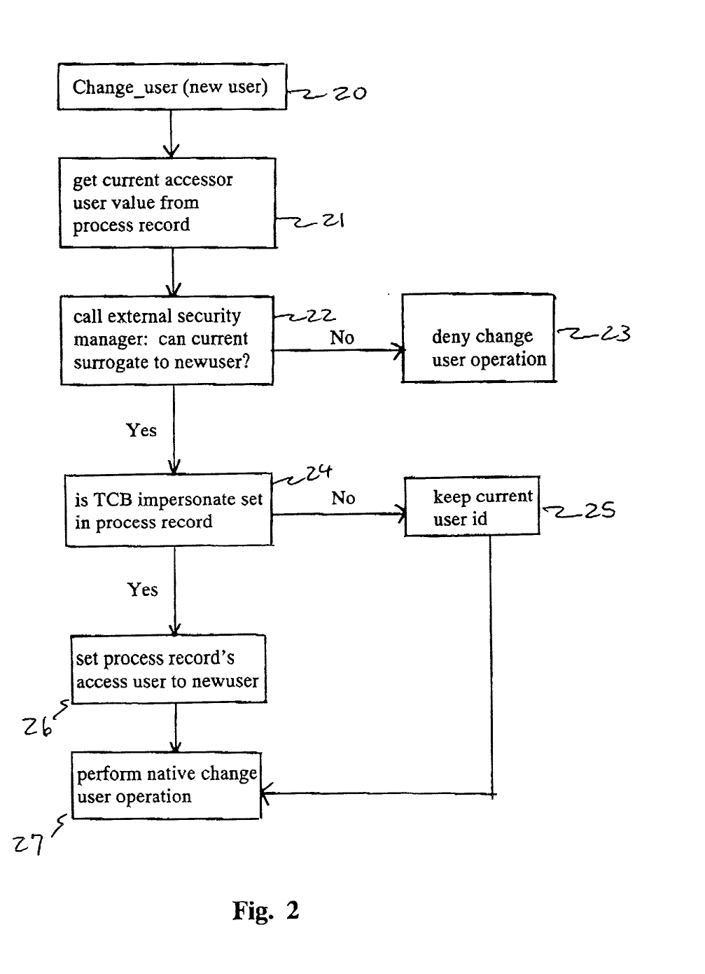

A second feature of this invention is the capability to control an impersonator program's ability to change its user identity. This feature of the invention will allow the specification of security policy to control which users an impersonator program can impersonate. FIG. 2 shows the steps involved in the algorithm that determines whether an impersonator program can change its' user identity to a new user. In this situation, the impersonator is now going to do some operation on behalf of another user. The first part of this procedure is that the impersonator program is going to change its user representation to be the new user under which it is going to do work 20. The algorithm of the present invention would determine the current user identity under which the impersonator application is running. This task is accomplished by getting the current accessor user value from a process record 21. When the impersonator starts to execute it executes under a given identity known as the “master identity”. When the impersonator program receives a request to do work, the impersonator program temporarily changes its identity to the identity of the user making the request. The impersonator program then does work for that user. At the completion of the task, the impersonator program changes back to the master identity. The impersonator program then waits for more work. In this part of the program, the security manager is checked to determine if that master identity can impersonate the identity of the user making the request of the impersonator program. This invention allows the security policy to control which users the impersonator program can impersonate. Therefore, in this process a security policy is checked to validate that the master identity can impersonate the requested identity. This operation of changing from one user to another is called a surrogate operation. To perform this step 22, there is a call to the security manager to determine if the current user can perform this surrogate to the new user. The surrogate operation check 22 is an essential part of any system check. If the impersonator program cannot impersonate the requested user, the algorithm denies the change user/surrogate operation 23 and the process terminates. The result is that the impersonator is not allowed to impersonate that new user. If the program can perform the surrogate operation, the next step is to determine if the program doing the surrogate operation is an impersonator program 24. To make this determination, the algorithm checks the TCB impersonator flag in the process record. If the TCB impersonator flag is not set, then the program is not an impersonator program. Therefore, the current maintained access identity of the application 25 should not change for the purpose of making authorization decisions in the external security manager. This step 25 is the default behavior for all non-impersonation programs. If the answer to step 24 is yes, then for that impersonator program, the particular process record is set such that the access user is now the new user 26 for the purpose of subsequent authorization decisions when that application attempts to access certain resources on the system. The final step is to perform the change in user identity 27.

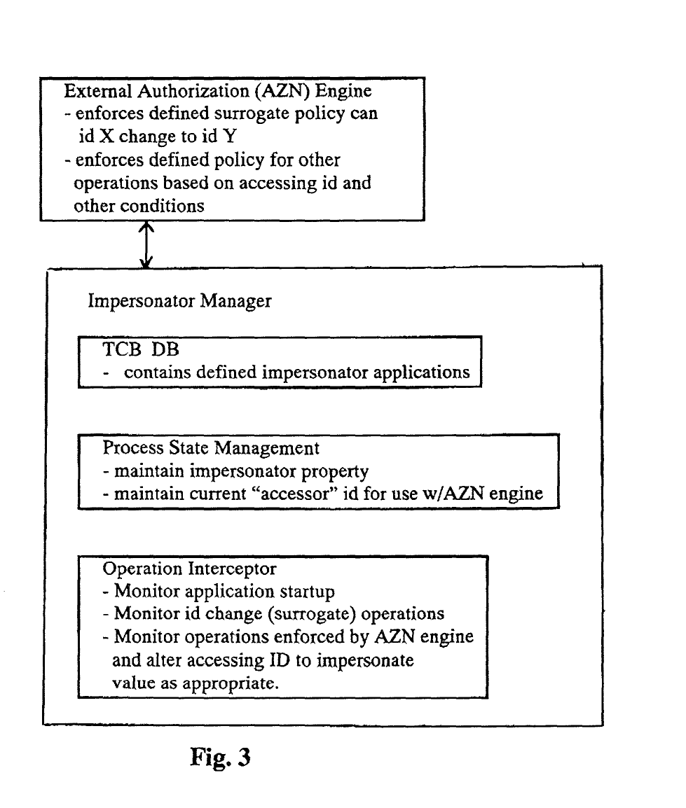

FIG. 3 shows the relationship between the security manager referred to as the external authorization engine (AZN) and the impersonator manager of the present invention. The external authorization engine 1) enforces defined surrogate policy that can enable identity X to change to identity Y; and 2) enforces defined policy for other operations based on accessing program identity and other system conditions. The Impersonator manager is comprised of the TCB database. This database contains defined impersonator applications. The impersonator manager also contains a process state management component. This component maintains impersonator property and maintains current “accessor” identity for use with the external authorization engine. The impersonator program also has an operation interceptor. This operator interceptor monitors application startup, monitors identity change (surrogate operations) and monitors operations enforced by the AZN engine and alters accessing identity to impersonation value as appropriate.

For file resources, which comprise executable programs, the security administrator can apply an impersonator TCB property. This capability dictates that if a running process is granted permission by the external security manager to change its user identity with a surrogate operation; then the process takes on the new surrogate user identity for subsequent authorization decisions on resources protected by the external security manager. Without the impersonator TCB attribute, the application would continue to be evaluated as its original user identity in external security manager decisions. The surrogate policy provides the additional security of controlling which users an impersonator application can represent. The detection of the impersonator property occurs when a file resource representing a program is started (exec ( )) on the system. At that time, the security manager verifies that the defined policy allows execution of the program for the accessing user and the access conditions. If execution is granted, then the resource's TCB attributes are checked to see if it is defined as an impersonator program. If so, this state is recorded in a process record, which is kept for the running instance of the program. Later when the process performs operations of interest to the external security manager, the process record can be checked for relevant attributes. On granted change user (surrogate) operations, the presence of the TCB impersonator attribute indicates the security manager should set the accessor identity to the new user identity. The accessor identity is also maintained in the process record. Finally, the native system change user operation is performed giving the application native system access as the new user for resources with only native system security controls. With the described method, an external security manager can support the powerful capability to enable impersonation for existing and new impersonator applications. A greater degree of security control is provided with reduced risk of compromised system security than would be possible with native UNIX security.

The present invention provides substantial benefits over other computer system security methods involving external security managers. If the impersonator attempts to access protected resources that where accessible only by the requester, it would fail to gain access and would be unable to perform its function. This invention allows this capability. The key features for this method are: 1) The ability to transparently extend a native impersonator program's behavior into another security manager's identity and policy space; 2) No requirement for modification to existing impersonator applications; 3) Management of a current external user identity and corresponding update for successful identity change by an impersonator program; and 4) Ability to reduce the privilege of an impersonator application without impacting its impersonator abilities. That is restrictive policy could be set on the root identity which an impersonator typically must run as. In addition, controls could be set on which identities the impersonator could assume

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for managing the execution of an impersonator application program in a computing system through the use of an external authorization program comprising the steps of:
determining at the initial execution of a computer application whether that application is an impersonator program;
determining whether a current user of the application program can change to a request user of said application; and
determining whether the external authorization program permits the execution of said application program; and
tracking the state of the impersonator program, which is permitted to execute until said impersonation program execution terminates.

2. The method as described in claim 1 wherein the step of determining whether a computer application program is an impersonation program further comprises the step of determining if the application program is defined in the external authorization program.

3. The method as described in claim 2 further comprising the step of determining whether the external authorization program permits a defined impersonator program to execute in the computing system.

4. The method as described in claim 1 wherein the state of the impersonator program is tracked in an internal process data structure record.

5. The method as described in claim 4 wherein said process record is marked with a TCB impersonator flag.

6. A method for managing the execution of an impersonator application program a computer system through the use of an external authorization program comprising the steps of:
determining at the initial execution of a computer application program whether the external authorization program permits the execution of said application program
determining whether that computer application program is an impersonator program; and
tracking the state of the impersonator program until said program terminates.

7. The method as described in claim 6 wherein the step of determining whether a computer application program is an impersonation program further comprises the step of determining if the application program is defined in the external authorization program.

8. The method as described in claim 7 further comprising the step of determining whether the external authorization program permits a defined impersonator program to execute in the computing system.

9. The method as described in claim 6 wherein the state of the impersonator program is tracked in an internal process data structure record.

10. The method as described in claim 9 wherein said process record is marked with a TCB impersonator flag.

11. A method for controlling an impersonator application program's ability to change its user identity, said controlling method being implemented in a computer system through the use of an external authorization program and comprising the steps of:
identifying a new user requesting an operation of an executing application program;
identifying the current user identity under which said application program is running;
determining whether said application program can change from current user to a new user to perform the requested operation; and
performing a change in user identity from current user to new user.

12. The method as described in claim 11 wherein the step of identifying the current user identity comprises obtaining the current accessor user value from a process record stored in the external authorization program.

13. The method as described in claim 12 the step of determining whether said application program can change from current user to a new user comprises the step of validating in the external authorization program that said application can change from the current user can change the new user.

14. The method as described in claim 13 further comprising the step of determining whether said application program is an impersonation program, said determination being made by checking a the TCB impersonator flag in a process record.

15. The method as described in claim 14 wherein an impersonator program initially executes under a master identity.

16. The method as described in claim 15 wherein said master identity is the current user.

17. The method as described in claim 14 further comprising the step of setting the process record such that the new user is now the current user for the purpose of subsequent authorization decisions.

18. A computer program product in a computer readable medium for managing the execution of an impersonator application program in a computing system through the use of an external authorization program, the computer program product comprising:
instructions for determining at the initial execution of a computer application whether that application is an impersonator program;
instructions for determining whether a current user of the application program can change to a request user of said application; and
instructions for determining whether the external authorization program permits the execution of said application program; and
instructions for tracking the state of the impersonator program which is permitted to execute until said impersonation program execution terminates.

19. The computer program product as described in claim 18 wherein the step of determining whether a computer application program is an impersonation program further comprises the step of determining if the application program is defined in the external authorization program.

20. The computer program product as described in claim 19 further comprising the step of determining whether the external authorization program permits a defined impersonator program to execute in the computing system.

21. The computer program product as described in claim 18 wherein the state of the impersonator program is tracked in an internal process data structure record.

22. The computer program product as described in claim 21 wherein said process record is marked with a TCB impersonator flag.

23. A computer program product in a computer readable medium for managing the execution of an impersonator application program a computer system through the use of an external authorization program comprising the steps of:
instructions for determining at the initial execution of a computer application program whether the external authorization program permits the execution of said application program
instructions for determining whether that computer application program is an impersonator program; and
instructions for tracking the state of the impersonator program until said program terminates.

24. A computer program product in a computer readable medium for controlling an impersonator application program's ability to change its user identity, said controlling method being implemented in a computer system through the use of an external authorization program and comprising the steps of:
instructions for identifying a new user requesting an operation of an executing application program;
instructions for identifying the current user identity under which said application program is running;
instructions for determining whether said application program can change from current user to a new user to perform the requested operation; and
instructions for performing a change in user identity from current user to new user.

25. A computer connectable to a distributed computing system including an impersonator application program for performing tasks on behalf of users in the distributed computing system comprising:
a processor;
a native operating system;
an external authorization program overlaying said native operating system and augmenting standard security controls of said native operating system; and
a means within said external authorization program for controlling the ability of said impersonator application program to execute in the computer system

26. The computer as described in claim 25 wherein said controlling means includes determining whether an application program is an impersonator program and determining whether the application program is allowed to execute in the computing system.

27. The computer as described in claim 25 wherein said impersonator program controlling means included a means for controlling the impersonator program's ability to change user identities.
